(19) United States
(12) Patent Application Publication
(10) Pub. No.: US 2011/0064866 A1
(43) Pub. Date: Mar. 17, 2011

(54) BLACK MULBERRY FLAVORED COMPOSITION AND METHOD OF PREPARATION

(76) Inventor: Jeffery Miles, Jeffersonville, GA (US)

(21) Appl. No.: 12/878,859

(22) Filed: Sep. 9, 2010

Related U.S. Application Data
(60) Provisional application No. 61/241,736, filed on Sep. 11, 2009.

(51) Int. Cl. A23L 1/222

(52) U.S. Cl. 426/650

(57) ABSTRACT

The present invention is a black mulberry flavored composition made up of water, tagette essence, blackberry juice concentrate, apple juice concentrate, blueberry essence, blueberry juice concentrate, grape essence, raspberry essence, ethyl alcohol and davana oil. There is also a method of manufacturing the black mulberry flavored composition through adding ingredients at various times and mixing those ingredients at various times during the method.

This application claims priority to U.S. Provisional Application 61/241,736 filed on Sep. 11, 2009, the entire disclosure of which is incorporated by reference.

### TECHNICAL FIELD & BACKGROUND

Commercially, black mulberries in their natural state are of little value to the marketplace due to their fragile nature. Black mulberry flavoring in its natural state can never be commercialized because the black mulberry is so rare that enough of the flavor can never be made using its raw product. There are no known effective ways of picking black mulberries except by hand. And when hand-picked, the black mulberries can still be damaged. The black mulberries can only be picked when they are fully ripen, which are only during a few weeks during the year. And then only small amounts of them can be gathered at any one time and the black mulberry trees also may or may not bear fruit from year to year. Therefore one way that black mulberry flavor can be stabilized and marketed is by providing a black mulberry flavored composition and a method of manufacturing the black mulberry flavored composition.

The present invention generally relates to a fruit flavored composition and method of manufacturing. More specifically, the invention is a black mulberry flavored composition and method of manufacturing.

It is an object of the invention to provide a black mulberry flavored composition.

It is an object of the invention to provide a method of manufacturing a black mulberry flavored composition.

What is really needed is a black mulberry flavored food flavoring composition and a method of manufacturing a black mulberry flavored food flavoring composition.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a flow chart of a method of manufacturing a black mulberry flavored composition, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

The composition of the present invention is a black mulberry flavored composition. The composition can be used to make milk shakes, ice cream, sherbet, yogurt, ice pops, sport drinks, wine coolers, smoothies, ice products and other desert products that are known in the art. The black mulberry flavored composition is a combination of artificial and natural flavors that is more stable and marketable than natural black mulberry flavor from natural black mulberries. The black mulberry flavored composition differs from the other desert products, since it tastes different from any other desert products in taste tasting trials.

### EXAMPLE #1

The following example further illustrates the black mulberry flavored composition but, of course, should not be construed as in any way limiting its scope. Example #1 includes the following formulation (by percentage):

Water—52.40%

Tagette Essence—0.0005%

Blackberry Juice Concentrate—5.00%

Apple Juice Concentrate—2.50%

Blueberry Essence—7.50%

Blueberry Juice Concentrate—10.00%

Grape Essence—2.50%

Raspberry Essence—5.00%

Ethyl Alcohol—15.099%

Davana Oil—0.0005%

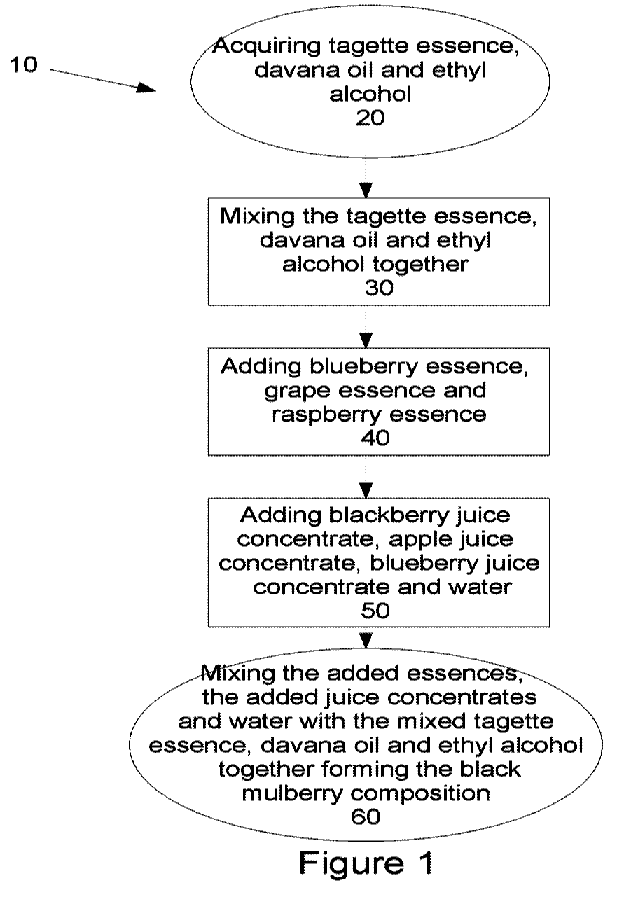

FIG. 1 illustrates a flow chart of a method of manufacturing a black mulberry flavored composition 10, in accordance with one embodiment of the present invention. The method of manufacturing a black mulberry flavored composition 10 comprises the steps of acquiring tagette essence, davana oil and ethyl alcohol 20, mixing the tagette essence, davana oil and ethyl alcohol together 30, adding blueberry essence, grape essence and raspberry essence to the mixed tagette essence, davana oil and ethyl alcohol 40, adding blackberry juice concentrate, apple juice concentrate, blueberry juice concentrate and water to the added essences and the tagette essence, davana oil and ethyl alcohol 50 and mixing the added essences, the added juice concentrates and water with the mixed tagette essence, davana oil and ethyl alcohol together forming the black mulberry composition 60.

The black mulberry composition manufactured is 52.40% water, 0.0005% tagette essence, 5.00% blackberry juice concentrate, 2.50% apple juice concentrate, 7.50% blueberry essence, 10.00% blueberry juice concentrate, 2.50% grape essence, 5.00% raspberry essence, 15.099% ethyl alcohol, 0.0005% davana oil, which is the same composition described in Example #1. Other percentages of the 10 ingredients of the black mulberry composition can also be manufactured as desired as well.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A black mulberry flavored composition, comprising:
water;
tagette essence;
blackberry juice concentrate;
apple juice concentrate;
blueberry essence;
blueberry juice concentrate;
grape essence;
raspberry essence;
ethyl alcohol; and
davana oil.

2. The composition according to claim 1, wherein said composition consists essentially of 52.40% water, 0.0005% tagette essence, 5.00% blackberry juice concentrate, 2.50% apple juice concentrate, 7.50% blueberry essence, 10.00% blueberry juice concentrate, 2.50% grape essence, 5.00% raspberry essence, 15.10% ethyl alcohol and 0.0005% davana oil.

3. A method of manufacturing a black mulberry flavored composition, comprising the steps of:
acquiring tagette essence, davana oil and ethyl alcohol;
mixing said tagette essence, davana oil and ethyl alcohol together;
adding blueberry essence, grape essence and raspberry essence to said mixed tagette essence, davana oil and ethyl alcohol;
adding blackberry juice concentrate, apple juice concentrate, blueberry juice concentrate and water to said added essences and said tagette essence, davana oil and ethyl alcohol; and
mixing said added essences, said added juice concentrates and water with said mixed tagette essence, davana oil and ethyl alcohol together forming said black mulberry composition.

4. The method according to claim 3, wherein said composition includes water, tagette essence, blackberry juice concentrate, apple juice concentrate, blueberry essence, blueberry juice concentrate, grape essence, raspberry essence, ethyl alcohol and davana oil.

5. The method according to claim 4, wherein said composition consists essentially of 52.40% water, 0.0005% tagette essence, 5.00% blackberry juice concentrate, 2.50% apple juice concentrate, 7.50% blueberry essence, 10.00% blueberry juice concentrate, 2.50% grape essence, 5.00% raspberry essence, 15.10% ethyl alcohol and 0.0005% davana oil.
